(19) United States
(12) Patent Application Publication
(10) Pub. No.: US 2025/0029192 A1
(43) Pub. Date: Jan. 23, 2025

(54) METHOD AND SYSTEM FOR PROPERTY IMPROVEMENT RECOMMENDATIONS

(71) Applicant: STATE FARM MUTUAL AUTOMOBILE INSURANCE COMPANY, Bloomington, IL (US)

(72) Inventors: Ross Wheeler, Scottsdale, AZ (US); Jose Ivan Gutierrez, Laveen, AZ (US); Anthony Welcome, Mesa, AZ (US); Steve Amancha, Tempe, AZ (US); Lauren Elise Mitchell, Phoenix, AZ (US); Anish Agarwal, Chandler, AZ (US)

(21) Appl. No.: 18/519,983

(22) Filed: Nov. 27, 2023

Related U.S. Application Data
(60) Provisional application No. 63/546,113, filed on Oct. 27, 2023.
(60) Provisional application No. 63/527,711, filed on Jul. 19, 2023.

(51) Int. Cl. G06Q 50/16

(52) U.S. Cl. CPC G06Q 50/163

(57) ABSTRACT

Apparatuses, systems and methods are disclosed for providing property improvement recommendations. The method comprises: (1) receiving, by one or more processors from a user, a first prompt associated with a property; (2) generating, by the one or more processors, a second prompt based upon the first prompt, data associated with the property and one or more property metrics associated with the property; (3) transmitting, by the one or more processors to a chatbot, the second prompt to generate a response, the response comprising a recommended action associated with the property; and/or (4) presenting, by the one or more processors, the response to the user.

### CROSS-REFERENCE TO RELATED APPLICATIONS

This application claims priority to and the benefit of the filing date of (1) provisional U.S. Patent Application No. 63/527,711 (entitled “METHOD AND SYSTEM FOR PROPERTY IMPROVEMENT RECOMMENDATIONS”), filed on Jul. 19, 2023; and (2) provisional U.S. Patent Application No. 63/546,113 (entitled “METHOD AND SYSTEM FOR PROPERTY IMPROVEMENT RECOMMENDATIONS”), filed on Mar. 7, 2023, the entire disclosure of each of which is hereby expressly incorporated herein by reference.

### FIELD OF THE INVENTION

The present disclosure generally relates to systems and methods for providing property improvement recommendations, and more particularly, using chatbots, voice bots, or other automated response bots for providing property improvement recommendations.

### BACKGROUND

Property improvements may include various activities aimed at enhancing the functionality, aesthetics, comfort, and value of a property. Property improvement projects may range from minor repairs and maintenance to major renovations and additions. However, planning and executing such projects may be challenging for homeowners, especially if they lack the necessary skills, knowledge, experience, or resources. Using traditional search engines to find property improvement recommendations may fail to satisfy a homeowner's customized needs.

Chatbots utilizing generative pre-trained transformer (GPT) models (such as ChatGPT®) are powerful tools that may generate realistic and engaging responses to user inputs. However, using a chatbot directly to provide property improvement recommendations may not always generate effective recommendations, especially when a highly customized recommendation is needed. The chatbot may make up erroneous or misleading facts, misinterpret information, or confuse different domains or entities, generally referred to in the art as “hallucinations.” Accordingly, utilizing chatbots to provide property improvement recommendations directly may fail to provide effective recommendations relevant to a specific property as the chatbots may confuse information of the specific property with information of other properties, make up information of the specific property, and/or make other mistakes generally associated with chatbots and, more generally, with GPT-based bots and similar artificial intelligence (AI) systems. Due to the unique nature of real property and improvements thereupon, these issues are particularly problematic with respect to property improvement recommendations.

The conventional methods or systems for providing property improvement recommendations may include additional ineffectiveness, inefficiencies, encumbrances, and/or other drawbacks.

### SUMMARY

The present embodiments may relate to, inter alia, systems and methods for providing property improvement recommendations using a chatbot, a voice bot, or other bot. Such systems and methods improve the functioning of such chatbots, voice bots, or other bots in providing higher quality recommendations to users through automatically generating higher quality prompts to increase the accuracy of information generated by such bots.

In one aspect, a computer-implemented method for providing property improvement recommendations may be provided. The computer-implemented method may be implemented via one or more local or remote processors, servers, transceivers, sensors, memory units, mobile devices, wearables, smart watches, smart contact lenses, smart glasses, augmented reality (AR) glasses, virtual reality (VR) headsets, mixed reality (MR) or extended reality glasses or headsets, voice bots or chatbots, ChatGPT® or other GPT-based bots, and/or other electronic or electrical components, which may be in wired or wireless communication with one another. For example, in one instance, the computer-implemented method may include: (1) receiving, by one or more processors from a user, a first prompt associated with a property; (2) generating, by the one or more processors, a second prompt based upon the first prompt, data associated with the property and one or more property metrics associated with the property; (3) transmitting, by the one or more processors to a chatbot, the second prompt to generate a response, the response comprising a recommended action associated with the property; and/or (4) presenting, by the one or more processors, the response to the user. In certain embodiments, the user may be a person, a computer, or a bot, such as ChatGPT-based bot, and the response may be a virtual, visual, online, graphical, text, text-based, textual, audible, verbal, code-based, or other response. The method may include additional, less, or alternate functionality or actions, including those discussed elsewhere herein.

In another aspect, a computer system for providing property improvement recommendations may be provided. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT® or other GPT-based bots, and/or other electronic or electrical components, which may be in wired or wireless communication with one another. For example, in one instance, the computer system may include one or more processors, and a non-transitory memory storing one or more instructions, the instructions, when executed by the one or more processors, cause the one or more processors to: (1) receive, from a user, a first prompt associated with a property; (2) generate a second prompt based upon the first prompt, data associated with the property and one or more property metrics associated with the property; (3) transmit, to a chatbot, the second prompt to generate a response, the response comprising a recommended action associated with the property; and/or (4) present the response to the user. In certain embodiments, the user may be a person, a computer, or a bot, such as ChatGPT-based bot, and the response may be a virtual, visual, online, graphical, text, text-based, textual, audible, verbal, code-based, or other response. Additional, alternate and/or fewer actions, steps, features and/or functionality may be included in an aspect and/or embodiments, including those described elsewhere herein.

In another aspect, a non-transitory computer-readable medium storing processor-executable instructions that, when executed by one or more processors, cause the one or more processors to: (1) receive, from a user, a first prompt associated with a property; (2) generate a second prompt based upon the first prompt, data associated with the property and one or more property metrics associated with the property; (3) transmit, to a chatbot, the second prompt to generate a response, the response comprising a recommended action associated with the property; and/or (4) present the response to the user. The instructions may direct additional, less, or alternate functionality, including that discussed elsewhere herein.

Additional, alternate and/or fewer actions, steps, features and/or functionality may be included in an aspect and/or embodiments, including those described elsewhere herein.

### BRIEF DESCRIPTION OF THE DRAWINGS

The figures described below depict various aspects of the applications, methods, and systems disclosed herein. It should be understood that each figure depicts one embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 depicts a block diagram of an exemplary computer environment in which methods and systems for providing property improvement recommendations are implemented according to certain embodiments.

FIG. 2 depicts a combined block and logic diagram in which exemplary computer-implemented methods and systems for training a machine learning (ML) chatbot or an artificial intelligence (AI) model are implemented according to certain embodiments.

FIG. 3 depicts an exemplary display of an application implementing a computer-based method for providing property improvement recommendations according to certain embodiments.

FIGS. 4A-4D depict flow diagrams of an exemplary computer-implemented method for providing property improvement recommendations according to certain embodiments.

Advantages will become more apparent to those skilled in the art from the following description of the embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### DETAILED DESCRIPTION

### Overview

The methods and systems disclosed herein generally relate to, inter alia, methods and systems for providing property improvement recommendations using a chatbot, voice bot, and/or another type of bot. Although the description herein refers to chatbots for convenience, it should be understood that voice bots or other types of bots providing automated responses may additionally or alternatively be used in any of the various embodiments.

In one aspect, upon receiving a first prompt associated with a property, the system disclosed herein may retrieve data and/or property metrics associated with the property. The system may then generate a second prompt based upon the first prompt, data, and/or property metrics associated with the property. As such, a chatbot that receives the second prompt may generate a response based upon the data and/or property metrics, rather than the user-provided prompt, which may not include sufficient information specifically related to their property. In this way, the present disclosure provides improved systems and methods for utilizing a chatbot to generate information by increasing the accuracy of information generated by a chatbot when the chatbot is asked for information related to users' properties.

Furthermore, the capability of a chatbot to “pay attention” to prompts is limited to a certain number of words (e.g., 25,000 words for ChatGPT-4) due to the complexity of the model it implements (e.g., a GPT model) and the limited computation resources allocated to a user. As the word number of a prompt increases, the computation resources required to handle the prompt increase significantly. In some embodiments, the system disclosed herein may identify and incorporate only the most relevant data and/or property metrics into the second prompt. In this way, the system improves the efficiency of information generation by the chatbot by using less computation resources. Moreover, with less information to pay attention to, the chatbot may generate responses more accurately.

### I. Exemplary Computing Environment

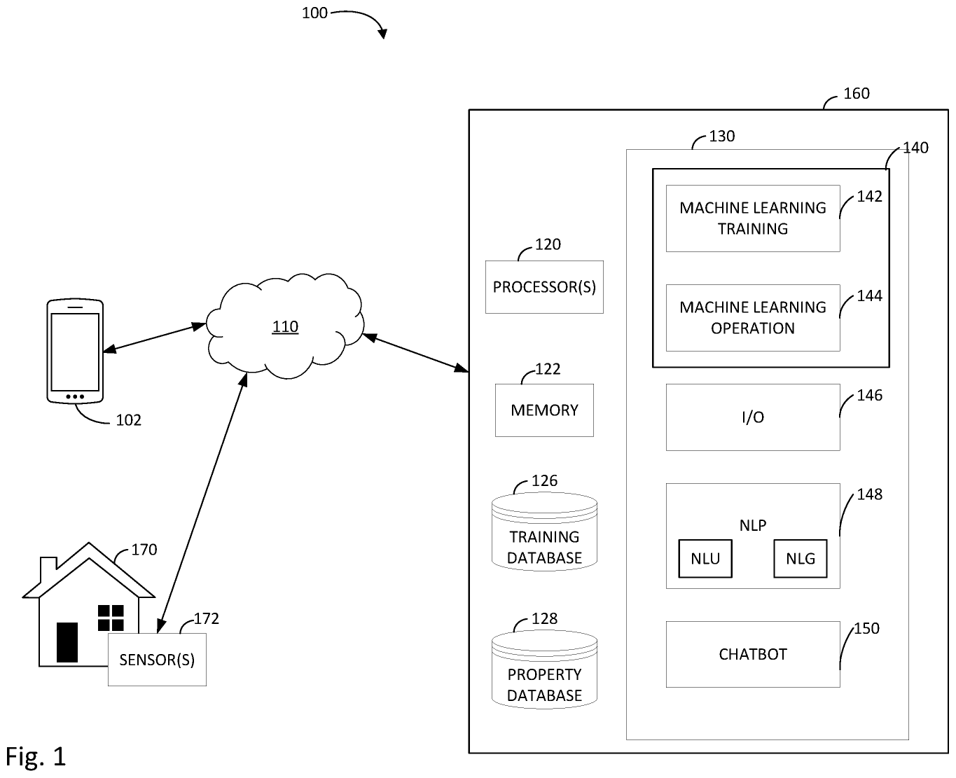

FIG. 1 depicts a block diagram of an exemplary computing environment 100 in which the method for providing improvement recommendations may be performed, in accordance with various aspects discussed herein.

In the exemplary aspect of FIG. 1, the computing environment 100 includes a user device 102. In various aspects, the user device 102 comprises one or more computing devices, which may comprise multiple, redundant, or replicated client computing devices accessed by one or more users. The computing environment 100 may further include an electronic network 110 communicatively coupling other aspects of the computing environment 100.

The user device 102 may be any suitable device, including one or more computers, mobile devices, wearables, smart watches, smart contact lenses, smart glasses, augmented reality glasses, virtual reality headsets, mixed or extended reality glasses or headsets, and/or other electronic or electrical component. The user device 102 may include a memory and a processor for, respectively, storing and executing one or more modules. The memory may include one or more suitable storage media such as a magnetic storage device, a solid-state drive, random access memory (RAM), etc. The user device 102 may access services or other components of the computing environment 100 via the network 110.

In one aspect, one or more servers 160 may perform the functionalities as part of a cloud network or may otherwise communicate with other hardware or software components within one or more cloud computing environments to send, retrieve, or otherwise analyze data or information described herein. For example, in certain aspects of the present techniques, the computing environment 100 may comprise an on-premise computing environment, a multi-cloud computing environment, a public cloud computing environment, a private cloud computing environment, and/or a hybrid cloud computing environment. For example, an entity (e.g., a business) may host one or more services in a public cloud computing environment (e.g., Alibaba Cloud, Amazon Web Services (AWS), Google Cloud, IBM Cloud, Microsoft Azure, etc.). The public cloud computing environment may be a traditional off-premise cloud (i.e., not physically hosted at a location owned/controlled by the business).

Alternatively, or in addition, aspects of the public cloud may be hosted on-premise at a location owned/controlled by an enterprise generating the customized code. The public cloud may be partitioned using visualization and multi-tenancy techniques and may include one or more infrastructure-as-a-service (IaaS) and/or platform-as-a-service (PaaS) services.

The network 110 may comprise any suitable network or networks, including a local area network (LAN), wide area network (WAN), Internet, or combination thereof. For example, the network 110 may include a wireless cellular service (e.g., 3G, 4G, 5G, 6G, etc.). Generally, the network 110 enables bidirectional communication between the servers 160 and a user device 102, and between the servers 160 and sensors 172 disposed at or proximal to a property 170. In one aspect, the network 110 may comprise a cellular base station, such as cell tower(s), communicating to the one or more components of the computing environment 100 via wired/wireless communications based upon any one or more of various mobile phone standards, including NMT, GSM, CDMA, UMTS, LTE, 5G, 6G, or the like. Additionally or alternatively, the network 110 may comprise one or more routers, wireless switches, or other such wireless connection points communicating to the components of the computing environment 100 via wireless communications based upon any one or more of various wireless standards, including by non-limiting example, IEEE 802.11a/b/c/g (Wi-Fi), Bluetooth, and/or the like.

The sensors 172 disposed at and/or proximal to the property 170 may be any sensor that collects data of the property. The sensors 172 may include cameras, microphones, thermometers, barometers, etc. In some embodiments, the sensors may communicate with each other and/or with the user device 102 via an Internet of Things (IoT) communication protocol (e.g., Advanced Message Queuing Protocol (AMQP), Bluetooth, LoRa, ZigBee, etc.). In some embodiments, the sensors may communicate with the user device 102 via the network 110.

The server 160 may include one or more processors 120. The processor 120 may include one or more suitable processors (e.g., central processing units (CPUs) and/or graphics processing units (GPUs)). The processor 120 may be connected to the memory 122 via a computer bus (not depicted) responsible for transmitting electronic data, data packets, or otherwise electronic signals to and from the processor 120 and memory 122 in order to implement or perform the machine-readable instructions, methods, processes, elements or limitations, as illustrated, depicted, or described for the various flowcharts, illustrations, diagrams, figures, and/or other disclosure herein. The processor 120 may interface with the memory 122 via a computer bus to execute an operating system (OS) and/or computing instructions contained therein, and/or to access other services/aspects. For example, the processor 120 may interface with the memory 122 via the computer bus to create, read, update, delete, or otherwise access or interact with the data stored in the memory 122, a training database 126, and/or a property database 128.

The memory 122 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The memory 122 may store an operating system (OS) (e.g., Microsoft Windows, Linux, UNIX, etc.) capable of facilitating the functionalities, apps, methods, or other software as discussed herein.

The memory 122 may store a plurality of computing modules 130, implemented as respective sets of computer-executable instructions (e.g., one or more source code libraries, trained machine learning (ML) models such as neural networks, convolutional neural networks, etc.), as described herein.

In general, a computer program or computer-based product, application, or code (e.g., the model(s), such as ML models, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor(s) 120 (e.g., working in connection with the respective operating system in memory 122) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.).

The training database 126 may be a relational database, such as Oracle, DB2, MySQL, a NoSQL based database, such as MongoDB, or another suitable database. The database 126 may store data and be used to train and/or operate one or more ML models, chatbots, and/or voice bots.

The property database 128 may be a relational database, such as Oracle, DB2, MySQL, a NoSQL based database, such as MongoDB, or another suitable database. The property database 128 may store property data and/or property metrics associated with user properties. For example, the property database 128 may store inventory data associated with the property, telematics data associated with the property, and/or other data associated with the property, and any feature vectors associated therewith (such as vectors associated with data labels). Accordingly, the collection of vectors included in the property database 128 may be referred to herein as a “vector database.” In some other embodiments, the vector database is a separate database than the property database 128. Because the property data may be difficult to reconstruct from the vectors, maintaining a separate vector database helps maintain the privacy of property data while still enabling the ML models, chatbots, and/or voice bots to act upon the pertinent characteristics thereof.

In one aspect, the computing modules 130 may include an ML module 140. The ML module 140 may include ML training module (MLTM) 142 and/or ML operation module (MLOM) 144. In some embodiments, at least one of a plurality of ML methods and algorithms may be applied by the ML module 140, which may include, but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, support vector machines and generative pre-trained transformers. In various embodiments, the implemented ML methods and algorithms are directed toward at least one of a plurality of categorizations of ML, such as supervised learning, unsupervised learning, and reinforcement learning.

In one aspect, the ML-based algorithms may be included as a library or package executed on server(s) 160. For example, libraries may include the TensorFlow based library, the PyTorch library, a HuggingFace library, and/or the scikit-learn Python library.

In one embodiment, the ML module 140 may employ supervised learning, which involves identifying patterns in existing data to make predictions about subsequently received data. Specifically, the ML module is “trained” (e.g., via MLTM 142) using training data, which includes example inputs and associated example outputs. Based upon the training data, the ML module 140 may generate a predictive function which maps outputs to inputs and may utilize the predictive function to generate ML outputs based upon data inputs. The exemplary inputs and exemplary outputs of the training data may include any of the data inputs or ML outputs described above. In the exemplary embodiments, a processing element may be trained by providing it with a large sample of data with known characteristics or features.

In another embodiment, the ML module 140 may employ unsupervised learning, which involves finding meaningful relationships in unorganized data. Unlike supervised learning, unsupervised learning does not involve user-initiated training based upon example inputs with associated outputs. Rather, in unsupervised learning, the ML module 140 may organize unlabeled data according to a relationship determined by at least one ML method/algorithm employed by the ML module 140. Unorganized data may include any combination of data inputs and/or ML outputs as described above.

In yet another embodiment, the ML module 140 may employ reinforcement learning, which involves optimizing outputs based upon feedback from a reward signal. Specifically, the ML module 140 may receive a user-defined reward signal definition, receive a data input, utilize a decision-making model to generate the ML output based upon the data input, receive a reward signal based upon the reward signal definition and the ML output, and alter the decision-making model so as to receive a stronger reward signal for subsequently generated ML outputs. Other types of ML may also be employed, including deep or combined learning techniques.

The MLTM 142 may receive labeled data at an input layer of a model having a networked layer architecture (e.g., an artificial neural network, a convolutional neural network, etc.) for training the one or more ML models. The received data may be propagated through one or more connected deep layers of the ML model to establish weights of one or more nodes, or neurons, of the respective layers. Initially, the weights may be initialized to random values, and one or more suitable activation functions may be chosen for the training process. The present techniques may include training a respective output layer of the one or more ML models. The output layer may be trained to output a prediction, for example.

The MLOM 144 may comprise a set of computer-executable instructions implementing ML loading, configuration, initialization and/or operation functionality. The MLOM 144 may include instructions for storing trained models. As discussed, once trained, the one or more trained ML models may be operated in inference mode, whereupon when provided with a de novo input that the model has not previously been provided, the model may output one or more predictions, classifications, etc., as described herein.

In some embodiments, the ML module 140 may include an ML model for transcribing text from audios. The ML model may include a plurality of parameters. The ML model may be trained with audios and corresponding texts. When training the ML model, the plurality of parameters (such as weights assigned to various features) may be adjusted iteratively. Adjusting the parameters may be based upon a difference between a transcription result and the text associated with the audio. For example, a particular audio associated with text “good” may be used to train the ML model. If the ML model transcribe the audio as “good,” in this particular training iteration, the ML module 140 may not adjust the parameters of the ML model. If the ML model transcribes the audio as “god,” the ML module 140 may moderately adjust the parameters of the ML model. If, for example, the ML model transcribes the audio as “but,” the ML module 140 may substantially adjust the parameters of the ML model. Although the adjustments described above are adjusted based upon the ML model's performance with respect to the evaluation of a single set of training data, one of ordinary skill in the art will appreciate that the adjustments may be based upon the ML model's performance with respect to a plurality of training data, e.g., based upon an average performance across the training data. When the transcription results meet a predetermined accuracy requirement, the ML model may be ready for use.

In some embodiments, the ML module 140 may include an ML model for extracting texts from images. The ML model may be trained with images or visual documents and corresponding texts in a similar manner described herein above with respect to training an ML model for transcribing texts from audios.

In some embodiments, the ML module 140 may include an ML model for encoding a semantic cluster into a vector. The ML model may be trained with a large corpus of text. The ML model may include a plurality of parameters. When training the ML model, the ML model may determine the values for the parameters based upon the word association reflected in the large corpus of text as described herein below. When the updates in the training process only produce minor changes in the parameter values, the ML model may be ready for use.

In some embodiments, the ML module 140 may include an ML model for determining factor scores based upon data associated with a property. The ML model may include a plurality of parameters. The ML model may be trained with data associated with a property and/or corresponding factor scores. When training the ML model, the plurality of parameters may be updated iteratively. Updating the parameters may be based upon a difference between (1) a factor score output by the ML model based upon the data input to the ML model and (2) a factor score in the training dataset corresponding to the data input to the ML model.

In some embodiments, the ML module 140 may include an ML model for determining association among different words and/or phrases in the context of property evaluation. The ML model may be trained with documents related to various aspects of properties. For example, when training the ML model, if two target words appear in the same article, the same paragraph, or the same sentence in a document for training, the parameters may be updated to reflect an association between the two target words. The update of the parameters may be based upon a distance between the two target words and/or other words between the two target words that show a relationship between the two target words (e.g., a word “is” between two target words shows equivalency, a word “not” between two target words shows distinction, etc.). The parameters may be updated iteratively every time the documents used for training reflect a different association between the two target words. When the updates in the training process only produce minor changes in the parameter values, the ML model may be ready for use.

In one aspect, the computing modules 130 may include an input/output (I/O) module 146, comprising a set of computer-executable instructions implementing communication functions. The I/O module 146 may include a communication component configured to communicate (e.g., send and receive) data via one or more external/network port(s) to one or more networks or local terminals, such as the computer network 110 and/or the user device 102 (for rendering or visualizing) described herein. In one aspect, the servers 160 may include a client-server platform technology such as ASP.NET, Java J2EE, Ruby on Rails, Node.js, a web service or online API, responsive for receiving and responding to electronic requests.

I/O module 146 may further include or implement an operator interface configured to present information to an administrator or operator and/or receive inputs from the administrator and/or operator. An operator interface may provide a display screen. The I/O module 146 may facilitate I/O components (e.g., ports, capacitive or resistive touch sensitive input panels, keys, buttons, lights, LEDs), which may be directly accessible via, or attached to, servers 160 or may be indirectly accessible via or attached to the user device 102. According to an aspect, an administrator or operator may access the servers 160 via the user device 102 to review information, make changes, input training data, initiate training via the MLTM 142, and/or perform other functions (e.g., operation of one or more trained models via the MLOM 144).

In one aspect, the computing modules 130 may include one or more NLP modules 148 comprising a set of computer-executable instructions implementing NLP, natural language understanding (NLU) and/or natural language generator (NLG) functionality. The NLP module 148 may be responsible for transforming the user input (e.g., unstructured conversational input such as speech or text) to an interpretable format. The NLP module 148 may include NLU processing to understand the intended meaning of utterances, among other things. The NLP module 148 may include NLG which may provide text summarization, machine translation, and/or dialog where structured data is transformed into natural conversational language (i.e., unstructured) for output to the user.

In one aspect, the computing modules 130 may include one or more chatbots and/or voice bots 150 which may be programmed to simulate human conversation, interact with users, understand their needs, and recommend an appropriate line of action with minimal and/or no human intervention, among other things. This may include providing the best response of any query that it receives and/or asking follow-up questions.

In some embodiments, the voice bots or chatbots 150 discussed herein may be configured to utilize artificial intelligence (AI) and/or ML techniques. For instance, the voice bot or chatbot 150 may be a GPT bot (e.g., may use ChatGPT or InstructGPT) or another type of AI or large language model (LLM) bot (e.g., may use Codex or a Google Bard). The voice bot or chatbot 150 may employ supervised or unsupervised ML techniques, which may be followed by, and/or used in conjunction with, reinforced or reinforcement learning techniques. The voice bot or chatbot 150 may employ the techniques utilized for ChatGPT, InstructGPT, Codex, Google Bard, or other similar AI or ML models or platforms.

Noted above, in some embodiments, a chatbot 150 or other computing device may be configured to implement ML, such that server 160 “learns” to analyze, organize, and/or process data without being explicitly programmed. ML may be implemented through ML methods and algorithms. In one exemplary embodiment, the ML module 140 may be configured to implement ML methods and algorithms.

During training, the MLTM 142 may access the training database 126 or any other data source for training data suitable to generate and/or train one or more ML models appropriate to recommend property improvements, e.g., as part of an “ML chatbot.” The training data may be sample data with assigned relevant and comprehensive labels (classes or tags) used to fit the parameters (weights) of an ML model with the goal of training it by example. In one aspect, once an appropriate ML model is trained and validated to provide accurate predictions and/or responses, the trained ML model may be loaded into MLOM 144 at runtime, may process the user inputs and/or utterances, may generate as an output conversational dialog, and may generated customized code implementing a customized insurance policy.

While various embodiments, examples, and/or aspects disclosed herein may include training and generating one or more chatbots 150 for the server 160 to load at runtime, it is also contemplated that one or more appropriately trained ML chatbots 150 may already exist (e.g., in the training database 126) such that the server 160 may load an existing trained chatbot 150 at runtime. It is further contemplated that the server 160 may retrain, update and/or otherwise alter an existing chatbot 150 before loading the model at runtime.

Although the computing environment 100 is shown to include one user device 102, one server 160, and one network 110, it should be understood that different numbers of user devices 102, networks 110, and/or servers 160 may be utilized. In one example, the computing environment 100 may include a plurality of servers 160 and hundreds or thousands of user devices 102, all of which may be interconnected via the network 110. Furthermore, the database storage or processing performed by the one or more servers 160 may be distributed among a plurality of servers 160 in an arrangement known as “cloud computing.” This configuration may provide various advantages, such as enabling near real-time uploads and downloads of information as well as periodic uploads and downloads of information.

The computing environment 100 may include additional, fewer, and/or alternate components, and may be configured to perform additional, fewer, or alternate actions, including components/actions described herein. Although the computing environment 100 is shown in FIG. 1 as including one instance of various components such as user device 102, server 160, and network 110, etc., various aspects include the computing environment 100 implementing any suitable number of any of the components shown in FIG. 1 and/or omitting any suitable ones of the components shown in FIG. 1. For instance, information described as being stored at server training database 126 may be stored at memory 122, and thus training database 126 may be omitted. Moreover, various aspects include the computing environment 100 including any suitable additional component(s) not shown in FIG. 1, such as but not limited to the exemplary components described above. Furthermore, it should be appreciated that additional and/or alternative connections between components shown in FIG. 1 may be implemented. As just one example, server 160 and user device 102 may be connected via a direct communication link (not shown in FIG. 1) instead of, or in addition to, via network 110.

### II. Exemplary Training of the ML Chatbot Model

An enterprise may be able to use programmable chatbots, such as the chatbot 150 and/or an ML chatbot (e.g., ChatGPT), to provide tailored, conversational customer service relevant to a line of business. The chatbot may be capable of understanding customer requests, providing relevant information, escalating issues, any of which may assist and/or replace the need for customer service assets of an enterprise. Additionally, the chatbot may generate data from customer interactions which the enterprise may use to personalize future support and/or improve the chatbot's functionality, e.g., when retraining and/or fine-tuning the chatbot.

In certain embodiments, the machine learning chatbot may be configured to utilize artificial intelligence and/or machine learning techniques. For instance, the machine learning chatbot or voice bot may be a ChatGPT chatbot. The machine learning chatbot may employ supervised or unsupervised machine learning techniques, which may be followed by, and/or used in conjunction with, reinforced or reinforcement learning techniques. The machine learning chatbot may employ the techniques utilized for ChatGPT. The machine learning chatbot may be configured to generate verbal, audible, visual, graphic, text, or textual output for either human or other bot/machine consumption or dialogue.

The ML chatbot may provide advance features as compared to a non-ML chatbot. For example, the ML chatbot may include and/or derive functionality from a large language model (LLM). The ML chatbot may be trained on a server, such as server 160, using large training datasets of text which may provide sophisticated capability for natural-language tasks, such as answering questions and/or holding conversations. The ML chatbot may include a general-purpose pretrained LLM which, when provided with a starting set of words (prompt) as an input, may attempt to provide an output (response) of the most likely set of words that follow from the input. In one aspect, the prompt may be provided to, and/or the response received from, the ML chatbot and/or any other ML model, via a user interface of the server. This may include a user interface device operably connected to the server via an I/O module, such as the I/O module 146. Exemplary user interface devices may include a touchscreen, a keyboard, a mouse, a microphone, a speaker, a display, and/or any other suitable user interface devices.

Multi-turn (i.e., back-and-forth) conversations may require LLMs to maintain context and coherence across multiple user prompts and/or utterances, which may require the ML chatbot to keep track of an entire conversation history as well as the current state of the conversation. The ML chatbot may rely on various techniques to engage in conversations with users, which may include the use of short-term and long-term memory. Short-term memory may temporarily store information that may be required for immediate use and may keep track of the current state of the conversation and/or to understand the user's latest input in order to generate an appropriate response. Long-term memory may include persistent storage of information which may be accessed over an extended period of time. The long-term memory may be used by the ML chatbot to store information about the user (e.g., preferences, chat history, etc.) and may be useful for improving an overall user experience by enabling the ML chatbot to personalize and/or provide more informed responses.

The system and methods to generate and/or train an ML chatbot model (e.g., via the ML module 140 of the server 160) which may be used the an ML chatbot, may consists of three steps: (1) a supervised fine-tuning (SFT) step where a pretrained language model (e.g., an LLM) may be fine-tuned on a relatively small amount of demonstration data curated by human labelers to learn a supervised policy (SFT ML model) which may generate responses/outputs from a selected list of prompts/inputs. The SFT ML model may represent a cursory model for what may be later developed and/or configured as the ML chatbot model; (2) a reward model step where human labelers may rank numerous SFT ML model responses to evaluate the responses which best mimic preferred human responses, thereby generating comparison data. The reward model may be trained on the comparison data; and/or (3) a policy optimization step in which the reward model may further fine-tune and improve the SFT ML model. The outcome of this step may be the ML chatbot model using an optimized policy. In one aspect, step one may take place only once, while steps two and three may be iterated continuously, e.g., more comparison data is collected on the current ML chatbot model, which may be used to optimize/update the reward model and/or further optimize/update the policy.

In some embodiments, the language model may be pre-trained by a set of vectors associated with a set of training data. The set of training data may include documents. Creating the set of vectors may include (1) extracting text from documents, (2) splitting the text into semantic clusters, and (3) encoding the semantic clusters as the set of vectors. The semantic clusters may be one or more words, a portion of a word, or a character. A distance between the vectors (e.g., a cosine distance, a Euclidean distance) may depend on a relevance between the semantic clusters corresponding to the vectors.

In some embodiments, the server 160 or an external computing device may encode the vectors using a trained machine learning model (such as the ML model in the ML module 140 described herein above). In other embodiments, the server 160 may encode the vectors using existing encoding tables and/or libraries.

### A. Supervised Fine-Tuning ML Model

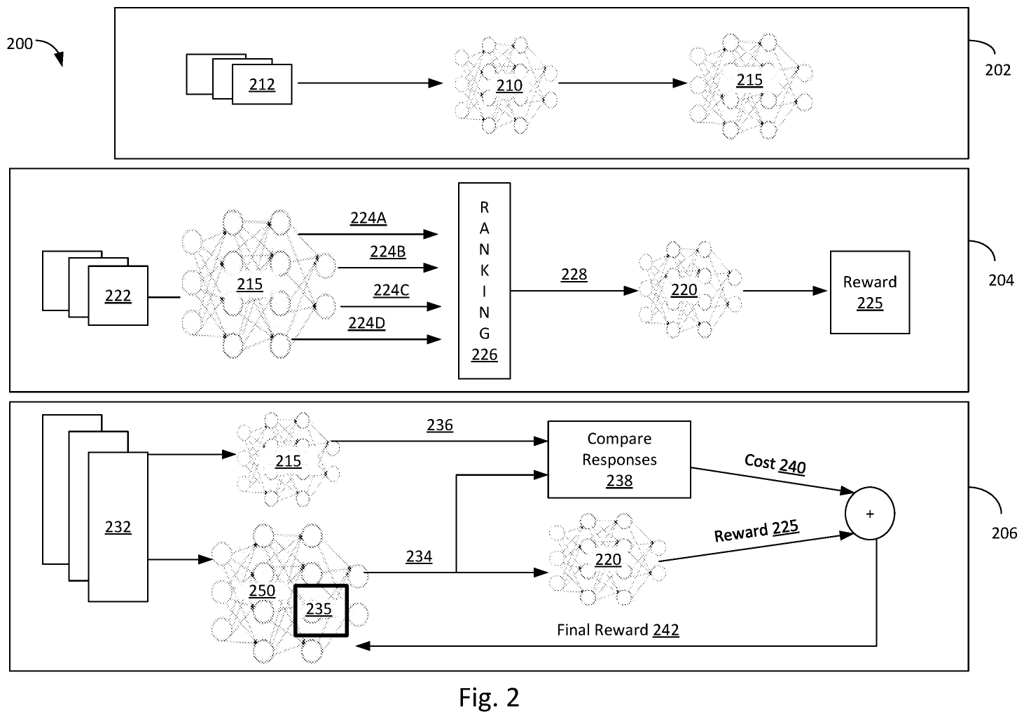

FIG. 2 depicts a combined block and logic diagram 200 for training an ML chatbot model, in which the techniques described herein may be implemented, according to some embodiments. Some of the blocks in FIG. 2 may represent hardware and/or software components, other blocks may represent data structures or memory storing these data structures, registers, or state variables (e.g., 212), and other blocks may represent output data (e.g., 225). Input and/or output signals may be represented by arrows labeled with corresponding signal names and/or other identifiers. The methods and systems may include one or more servers 202, 204, 206, such as the server 160 or an external computing device.

In one aspect, the server 202 may fine-tune a pretrained language model 210. The pretrained language model 210 may be obtained by the server 202 and be stored in a memory, such as the memory 122. The pretrained language model 210 may be loaded into an ML training module, such as MLTM 142, by the server 202 for retraining/fine-tuning. A supervised training dataset 212 may be used to fine-tune the pretrained language model 210 wherein each data input prompt to the pretrained language model 210 may have a known output response for the pretrained language model 210 to learn from. The supervised training dataset 212 may be stored in a memory of the server 202, e.g., the memory 122 or the training database 126. In one aspect, the data labelers may create the supervised training dataset 212 prompts and appropriate responses. The pretrained language model 210 may be fine-tuned using the supervised training dataset 212 resulting in the SFT ML model 215 which may provide appropriate responses to user prompts once trained. The trained SFT ML model 215 may be stored in a memory of the server 202, e.g., memory 122 and/or the training database 126.

In some embodiments, the server 202 may fine-tune the pretrained language model 210 using a set of vectors associated with a set of training data. In some instances, the set of training data may include (1) prompts associated with properties, (2) data associated with properties, (3) property metrics associated with properties, and/or (4) recommendations associated with the data associated with properties, the property metrics associated with properties, and the prompts associated with the properties. Creating the set of vectors may include (1) splitting the text of the prompts into semantic clusters, and (2) encoding the semantic clusters as the set of vectors. The semantic clusters may be one or more words, a portion of a word, or a character. A distance between the vectors (e.g., a cosine distance, a Euclidean distance) may depend on a relevance between the semantic clusters corresponding to the vectors.

In some embodiments, the recommendations used to train the chatbot include an improvement to a structure of a property, a replacement of a structure of a property, an addition of a structure to a property, and/or a removal of a structure from a property. In some embodiments, the recommendations used to train the chatbot further include step-by-step instructions for performing the recommended action.

### B. Training the Reward Model

In one aspect, training the ML chatbot model 250 may include the server 204 training a reward model 220 to provide as an output a scaler value/reward 225. The reward model 220 may be required to leverage Reinforcement Learning with Human Feedback (RLHF) in which a model (e.g., ML chatbot model 250) learns to produce outputs which maximize its reward 225, and in doing so may provide responses which are better aligned to user prompts.

Training the reward model 220 may include the server 204 providing a single prompt 222 to the SFT ML model 215 as an input. The input prompt 222 may be provided via an input device (e.g., a keyboard) via the I/O module of the server, such as I/O module 146. The prompt 222 may be previously unknown to the SFT ML model 215, e.g., the labelers may generate new prompt data, the prompt 222 may include testing data stored on the training database 126, and/or any other suitable prompt data. The SFT ML model 215 may generate multiple, different output responses 224A, 224B, 224D, 224D to the single prompt 222. The server 204 may output the responses 224A, 224B, 224D, 224D via an I/O module (e.g., I/O module 146) to a user interface device, such as a display (e.g., as text responses), a speaker (e.g., as audio/voice responses), and/or any other suitable manner of output of the responses 224A, 224B, 224D, 224D for review by the data labelers.

The data labelers may provide feedback via the server 204 on the responses 224A, 224B, 224D, 224D when ranking 226 them from best to worst based upon the prompt-response pairs. The data labelers may rank 226 the responses 224A, 224B, 224D, 224D by labeling the associated data. The ranked prompt-response pairs 228 may be used to train the reward model 220. In one aspect, the server 204 may load the reward model 220 via the ML module (e.g., the ML module 140) and train the reward model 220 using the ranked response pairs 228 as input. The reward model 220 may provide as an output the scalar reward 225.

In one aspect, the scalar reward 225 may include a value numerically representing a human preference for the best and/or most expected response to a prompt, i.e., a higher scaler reward value may indicate the user is more likely to prefer that response, and a lower scalar reward may indicate that the user is less likely to prefer that response. For example, inputting the “winning” prompt-response (i.e., input-output) pair data to the reward model 220 may generate a winning reward. Inputting a “losing” prompt-response pair data to the same reward model 220 may generate a losing reward. The reward model 220 and/or scalar reward 225 may be updated based upon labelers ranking 226 additional prompt-response pairs generated in response to additional prompts 222.

In one example, a data labeler may provide to the SFT ML model 215 as an input prompt 222, “Describe the sky.” The input may be provided by the labeler via the user device 102 over network 110 to the server 204 running a chatbot application utilizing the SFT ML model 215. The SFT ML model 215 may provide as output responses to the labeler via the user device 102: (i) “the sky is above” 224A; (ii) “the sky includes the atmosphere and may be considered a place between the ground and outer space” 224B; and (iii) “the sky is heavenly” 224D. The data labeler may rank 226, via labeling the prompt-response pairs, prompt-response pair 222/224B as the most preferred answer; prompt-response pair 222/224A as a less preferred answer; and prompt-response 222/224D as the least preferred answer. The labeler may rank 226 the prompt-response pair data in any suitable manner. The ranked prompt-response pairs 228 may be provided to the reward model 220 to generate the scalar reward 225.

While the reward model 220 may provide the scalar reward 225 as an output, the reward model 220 may not generate a response (e.g., text). Rather, the scalar reward 225 may be used by a version of the SFT ML model 215 to generate more accurate responses to prompts, i.e., the SFT model 215 may generate the response such as text to the prompt, and the reward model 220 may receive the response to generate a scalar reward 225 of how well humans perceive it. Reinforcement learning may optimize the SFT model 215 with respect to the reward model 220 which may realize the configured ML chatbot model 250.

### C. RLHF to Train the ML Chatbot Model

In one aspect, the server 206 may train the ML chatbot model 250 (e.g., via the ML module 140) to generate a response 234 to a random, new and/or previously unknown user prompt 232. To generate the response 234, the ML chatbot model 250 may use a policy 235 (e.g., algorithm) which it learns during training of the reward model 220, and in doing so may advance from the SFT model 215 to the ML chatbot model 250. The policy 235 may represent a strategy that the ML chatbot model 250 learns to maximize its reward 225. As discussed herein, based upon prompt-response pairs, a human labeler may continuously provide feedback to assist in determining how well the ML chatbot's 250 responses match expected responses to determine rewards 225. The rewards 225 may feed back into the ML chatbot model 250 to evolve the policy 235. Thus, the policy 235 may adjust the parameters of the ML chatbot model 250 based upon the rewards 225 it receives for generating good responses. The policy 235 may update as the ML chatbot model 250 provides responses 234 to additional prompts 232.

In one aspect, the response 234 of the ML chatbot model 250 using the policy 235 based upon the reward 225 may be compared using a cost function 238 to the SFT ML model 215 (which may not use a policy) response 236 of the same prompt 232. The cost function 238 may be trained in a similar manner and/or contemporaneous with the reward model 220. The server 206 may compute a cost 240 based upon the cost function 238 of the responses 234, 236. The cost 240 may reduce the distance between the responses 234, 236, i.e., a statistical distance measuring how one probability distribution is different from a second, in one aspect the response 234 of the ML chatbot model 250 versus the response 236 of the SFT model 215. Using the cost 240 to reduce the distance between the responses 234, 236 may avoid a server over-optimizing the reward model 220 and deviating too drastically from the human-intended/preferred response. Without the cost 240, the ML chatbot model 250 optimizations may result in generating responses 234 which are unreasonable but may still result in the reward model 220 outputting a high reward 225.

In one aspect, the responses 234 of the ML chatbot model 250 using the current policy 235 may be passed by the server 206 to the rewards model 220, which may return the scalar reward 225. The ML chatbot model 250 response 234 may be compared via the cost function 238 to the SFT ML model 215 response 236 by the server 206 to compute the cost 240. The server 206 may generate a final reward 242 which may include the scalar reward 225 offset and/or restricted by the cost 240. The final reward 242 may be provided by the server 206 to the ML chatbot model 250 and may update the policy 235, which in turn may improve the functionality of the ML chatbot model 250.

To optimize the ML chatbot 250 over time, RLHF via the human labeler feedback may continue ranking 226 responses of the ML chatbot model 250 versus outputs of earlier/other versions of the SFT ML model 215, i.e., providing positive or negative rewards 225. The RLHF may allow the servers (e.g., servers 204, 206) to continue iteratively updating the reward model 220 and/or the policy 235. As a result, the ML chatbot model 250 may be retrained and/or fine-tuned based upon the human feedback via the RLHF process, and throughout continuing conversations may become increasingly efficient.

Although multiple servers 202, 204, 206 are depicted in the exemplary block and logic diagram 200, each providing one of the three steps of the overall ML chatbot model 250 training, fewer and/or additional servers may be utilized and/or may provide the one or more steps of the ML chatbot model 250 training. In one aspect, one server may provide the entire ML chatbot model 250 training.

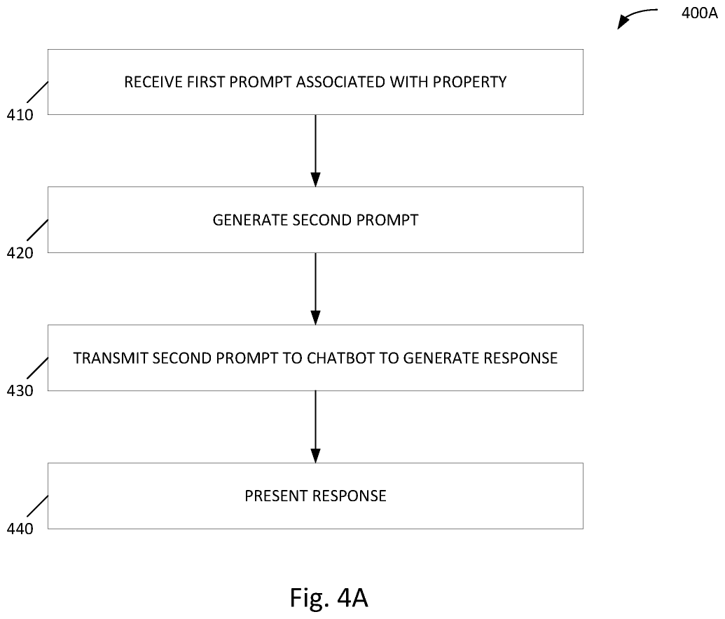

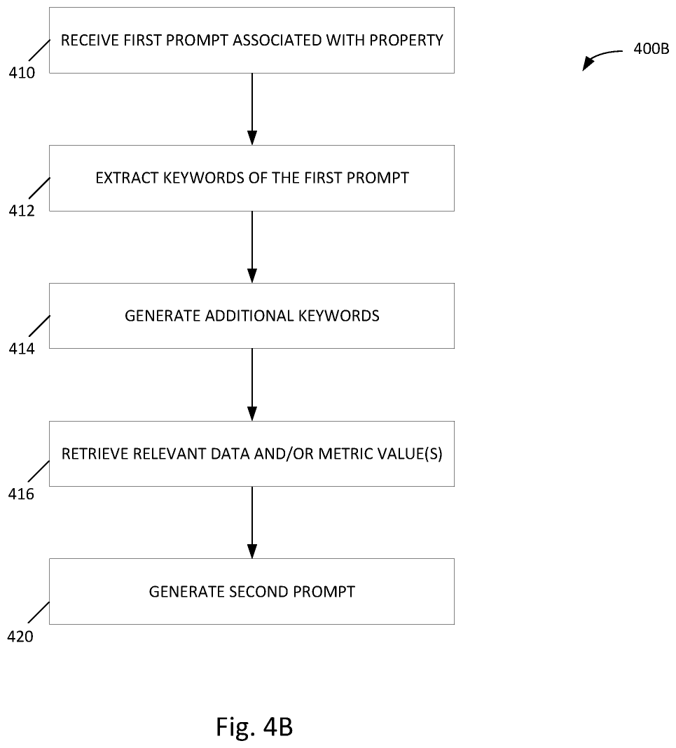

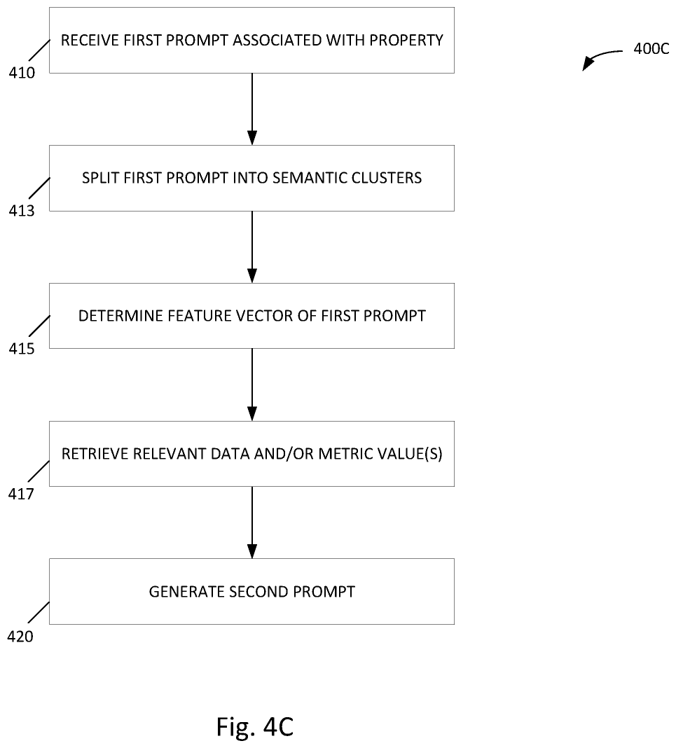

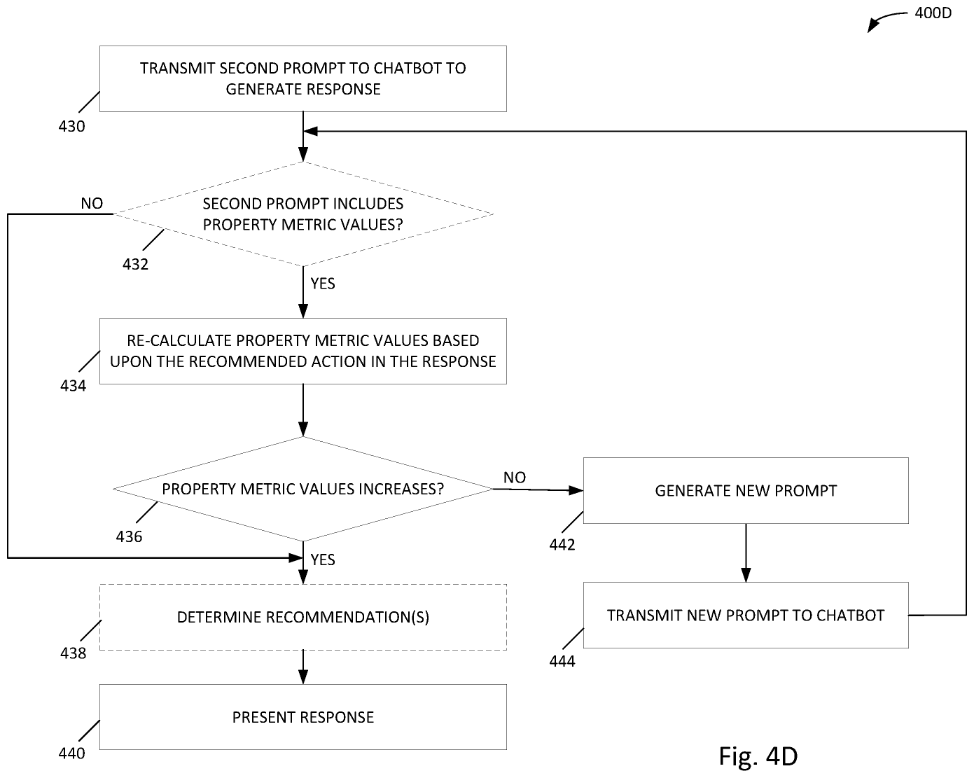

In some embodiments, the server 204 may train and/or fine-tune the ML chatbot model 250 in connection with a feedback server (such as the server 160 or an external computing device) that provides feedback to the ML chatbot model 250. While training and/or fine-tuning the ML chatbot model 250, the ML chatbot model 250 may output one or more recommend actions for improving a property based upon an input prompt. The feedback server may receive the one or more recommendations output by the ML chatbot model 250 and then determine a change of one or more metric values associated with the property when implementing the one or more recommendations, for example, by applying the techniques described herein below with respect to block 434 of FIG. 4D. The feedback server may then provide the change to the server 204. Accordingly, the reward model 220 and/or the cost function 238 may utilize the change in one or more metric values associated with the property as input to determine the scalar reward 225 and/or the cost 240 associated with the one or more recommendations. In this way, the ML chatbot model 250 may be trained and/or fine-tuned to provide recommendations for improving a property that maximize the metric values associated with the property.

### III. Exemplary Graphical User Interface (GUI)

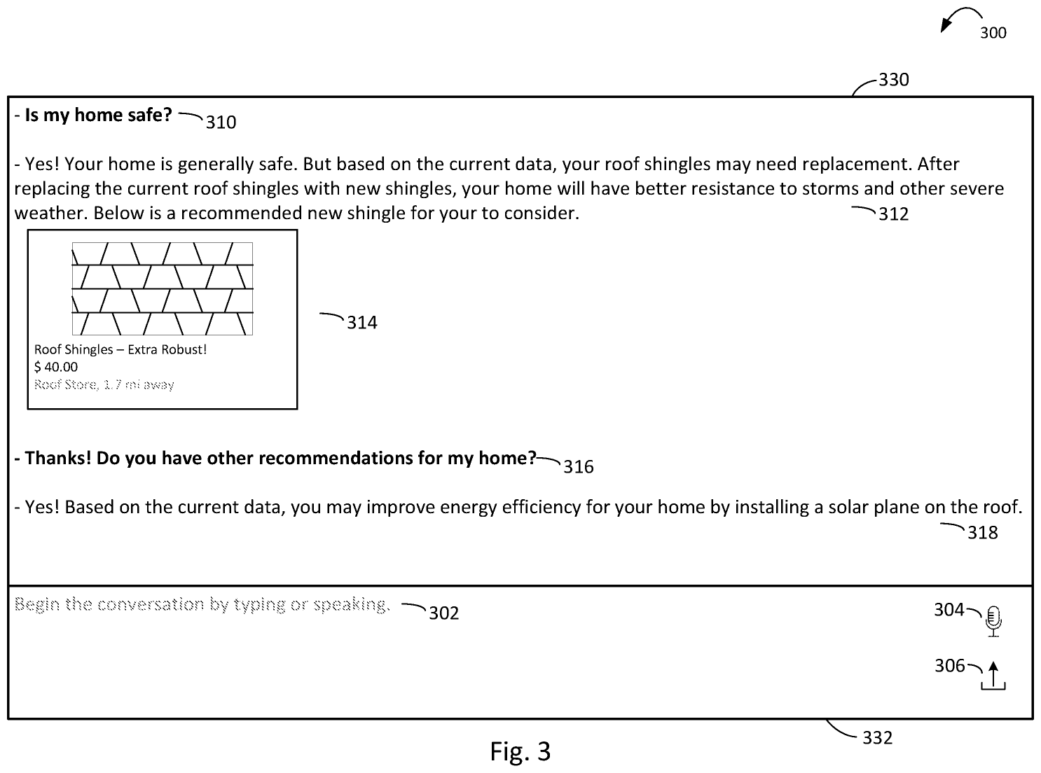

FIG. 3 depicts an exemplary GUI 300 of an application implementing a method disclosed herein for providing customer-specific information, according to one embodiment. The GUI 300 may include a chat interface 330 via which the GUI 300 presents the user's inputs and responses generated to the user's inputs.

Further, the GUI 300 may include an input interface 332. The GUI 300 may display a thread 302 in the input interface to prompt the user to input information into the GUI 300. The user may input information via text (e.g., by typing) and/or audio (e.g., by speaking), and/or uploading files (e.g., images, videos, etc.). In scenarios where the user responds by typing, the user may type in the input interface 332. In scenarios where the user responds by speaking, the user may interact with a selectable element 304 to begin speaking. The user device 102 may transcribe the audio data (e.g., using the ML module 140) and enter the transcribed audio into the chat interface 330.

In some embodiments, the GUI 300 may include a selectable element 306 to allow a user to upload files. For example, the user may wish to upload files associated with a customer when the information associated with the customer is not sufficient to answer the user's question. In such scenarios, the user may interact with selectable element 306 to begin uploading files.

Upon the user entering an input, the GUI 300 may present the user's input in the chat interface 330, such as the inputs 310 and 316. The user's input may be a question associated with a property, such as the input 310. The application may generate a response to the question and present the response in the chat interface 330, such as the responses 312 and 318.

In some embodiments, the response may include a recommended action associated with the property, such as “your roof shingles may need replacement” in response 312 and “you may improve energy efficiency for your home by installing a solar panel on the roof” in response 318.

In some embodiments, the response may include an indication of a product and/or service associated with the recommended action, such as the indication of recommended shingles 314. The indication of a product and/or service may be selectable. For example, responsive to the user selects the indication 314, the GUI 300 may direct the user to a shopping webpage of the product and/or service shown in the indication 314.

### IV. Exemplary Computer-Implemented Methods

FIG. 4A depicts a flow diagram of an exemplary computer-implemented method 400A for providing property improvement recommendations, according to one embodiment. The method 400A may be performed by one or more processors of a server (such as the processor(s) 120 of the server 160 in FIG. 1).

The method 400A may begin when a user inputs a first prompt to a user device (such as the user device 102 of FIG. 1). The first prompt may be a question associated with a property (such as the inputs 310 and 316). The question may relate to various aspects of a property, including but not limited to home safety, fire protection, home automation, sustainability, and/or energy efficiencies.

At block 410, the server may receive the first prompt from the user device. In some embodiments, the first prompt and/or question may be in verbal, audible, visual, textual, graphical, document, and/or other form or format.

When the first prompt is verbal or audible, the server may transcribe the prompt into texts and process the texts accordingly. In some embodiments, transcribing the first prompt may include (1) pre-processing the first prompt (e.g., removing white noise, removing sounds outside of a frequency band of human voice, etc.), and (2) using a trained machine learning model (such as an ML model in the ML module 140) to generate texts based upon the first prompt.

When the first prompt is visual or graphical, the server may extract texts from the visual or graphical prompt. In some embodiments, the texts may be extracted using optical character recognition (OCR) techniques. In other embodiments, the texts may be extracted using a trained machine learning model (such as an ML model in the ML module 140).

At block 420, the server may generate a second prompt based upon the first prompt, data associated with the property, and/or one or more property metric values associated with the property.

The data associated with the property may be stored in a database (such as the property database 128) and indicate a state of the property. In some embodiments, the data associated with the property may include inventory data associated with the property, telematics data associated with the property, and/or other data associated with the property. In some embodiments, the data may be an image associated with the property, an audio associated with the property, a video associated with property, and/or in other appropriate formats.

The inventory data may indicate what structures, furniture, personal items, etc. are attached to and/or located in the property and information of the structures, furniture, personal items, etc. For example, the information of a window may include a brand of the window, a material of the window, an installation date of the window, last maintenance time of the window, etc.

The telematics data may be collected by the sensors disposed at or proximal to the property (such as the sensors 172). The telematics data may include temperature of the property at a particular time, noise surrounding the property at a particular time, weather events affecting the property at a particular time, etc. In some embodiments, the sensors may be configured to collect additional data responsive detecting a particular type of data. For example, when a sensor detects an occurrence of a hail event (e.g., detecting the hail even by recognizing images or sounds that indicate the occurrence of the hail event), the sensor may collect additional data during the hail event, such as increasing the frequency of taking pictures by a camera, enabling a microphone to record audio, enabling a thermometer to record temperature, etc. Other examples of the particular type of data include an abnormal sound (e.g., sound of high frequency in the human voice range persisting for a particular time period that may represent human screaming, abrupt sound of high volume that may represent a gun shot or a break-in), inhospitable indoor temperature, outdoor temperature outside of a particular temperature range (e.g., a temperature that might cause property damages), occurrence of weather events (e.g., raining, snowing), unrecognized human faces, etc.

The one or more property metric values associated with the property may present an evaluation of the property. In some embodiments, the one or more metrics may be a score (e.g., a numeral value) representing an overall status of the property with respect to one or more aspects. For example, the score may represent a comprehensive evaluation of the property, including but not limited to home safety, fire protection, home automation, sustainability, etc. In other embodiments, the one or more metrics may be a set of scores (e.g., a vector comprising a plurality of scores), each score representing evaluation of a respective aspect of the property. For example, the set of scores may be a vector comprising a score of home safety, a score of fire protection, a score of home automation, a score of sustainability, etc. that is stored in the property database.

In some embodiments, the one or more metrics may be determined based upon historical data associated with the property. In other embodiments, the one or more metrics may be determined based upon factor scores. The factor scores may be associated with a specific aspect of the property, including but not limited to an environment score, a location score, a first responder score, a construction score, a usage score, an occupancy score, a risk score, home safety score, a fire protection score, a home automation score, and/or a sustainability score. In some instances, a factor score may be determined by a particular formula using data associated with the property. In other instances, the factor scores are determined by a trained machine learning model (e.g., via the ML module 140) or by artificial intelligence techniques. In some instances, the factor scores may be maintained in a database (such as the property database 128). Further description of how the scores and/or factors may be generated are described in U.S. application Ser. Nos. 17/816,379, 17/973,099, 17/816,391, 17/973,108, 18/200,181, 63/471,868, 63/524,336, 63/524,342, and 63/524,343, the entire disclosure of each of which are hereby incorporated by reference.

In some embodiments, the server may generate the second prompt may combine the first prompt with the data associated with the property, and/or one or more property metric values associated with the property. For example, the server may combine the first prompt “is my home safe?” with an image of a roof of the user's home (i.e., the data associated with the property) to generate a second prompt “Is the user's home safe based upon the image below?” and include the image in the second prompt. In some embodiments, the server may incorporate a sentence in the second prompt to cause the chatbot to recommend a property improvement. For example, the server may generate a second prompt “Is the user's home safe based upon the image below? Please also recommend actions to improve the user's home safety” and include the image in the second prompt. It should be appreciated that this second prompt may not be displayed to the user via the user interface.

Turning to FIG. 4B, in some embodiments, to generate a second prompt, the server may determine and retrieve data and/or metric values associated with the property based upon the first prompt. To this end, at block 412, upon receiving the first prompt, the server may extract keywords from the first prompt. For example, for the question “Is my home safe?” in input 310, the server may extract “my home” and “safe” as keywords. The server may identify that the first prompt is associated with the user's home based upon the key words “my home.” The server may identify relevant data and/or property metrics associated with the user's home based upon the keyword “safe.”

In some embodiments, at block 414, the server may generate additional keywords based upon the extracted keywords. The additional keywords may be words that are semantically close to the extracted keywords. For example, when the extracted keyword is “safe,” the additional keywords may be “safety,” “security,” etc. To this end, the server may encode the extracted keyword into a vector, calculate distances between the vector of the extracted keyword and vectors of candidate additional keywords (such as all commonly used words in a dictionary), and choose one or more additional keywords based upon the distances. The distance between vectors of the keywords and candidate additional keywords reflects a semantic similarity between them. An additional keyword may be selected if the distance between the vector of the extracted keyword and the vector of the additional keyword is lower than a threshold distance, and/or if the distance between the vector of the extracted keyword and the vector of the additional keyword is one of the smallest distances between the vector of the extracted keyword and the vectors of the candidate additional keywords.

Additionally or alternatively, the additional keywords may be words that are associated with the extracted keywords. To this end, related words may be associated each other. For example, the word “safe” may be associated with “lock,” “fire protection,” “window,” “roof,” “security system,” etc. The server or other computing devices may perform the association using a trained machine learning model (such as the ML model in the ML module 140).

At block 416, the server may retrieve data and/or metric values associated with the property that are relevant to the first prompt. To this end, the server may compare the extracted keywords and/or the additional keywords with labels associated with the data and property metrics. The labels may be indicative of what the data and/or metrics represent. For example, if the data associated with the property is an image of the roof, a label of the image may be “roof.” The server may determine the extracted keyword “safe” and/or the additional keyword “roof” are close to and/or associated with the data label “roof,” and retrieve the image of the roof as data relevant to the first prompt. In another example, a property metric value may be related to fire protection. Accordingly, a label of the metric value may be “fire protection.” The server may determine the extracted keyword “safe” and/or the additional keyword “fire protection” are close to and/or associated with the data label “fire protection,” and retrieve the metric value related to fire protection as a metric value relevant to the first prompt.

The server may then generate a second prompt based upon the retrieved data and/or metric values as described above with respect to block 420.

Turning to FIG. 4C, in some embodiments, upon receiving the first prompt at block 410, the server may encode the first prompt to create a feature vector. Advantageously, a feature vector created based upon the first prompt may keep context information of the first prompt and thus be more effective for identifying relevant data and/or property metrics.

At block 413, the server may split texts of the first prompt into semantic clusters. A semantic cluster may be one or more words, a portion of a word, and/or a character. When the semantic cluster is a word, the server may split sentences by spaces and punctuation. When the semantic cluster is phrase comprising more than one words, the server may first split the sentence into words, and then cluster related words together. For example, the server may compare the words with a table of commonly used phrases and determine a plurality of consecutive words to be a semantic cluster if the plurality of consecutive words forms a phrase in the table. When the semantic cluster is a portion of word, the server may (i) first split the sentence into words, and then further split each word if needed, or (ii) split the sentence into words and word portions (when appropriate) directly. For example, the server may compare the words with a table of predetermined word portions and determine a particular portion of a word to be a semantic cluster if the particular portion is in the table.

At block 415, the server may determine a feature vector of the first prompt based upon the semantic clusters. In some instances, the server may determine the feature vector by encoding the semantic clusters into the feature vector directly. Various techniques may be used to perform this step, such as Bag of Words. In other instances, the server may determine the feature vector by (1) encoding the semantic clusters as a set of vectors, and (2) determining a feature vector based upon the set of vectors associated with the semantic clusters.

Various techniques may be used to encode a semantic cluster into a vector, such as word2vec, which uses a machine model trained with a large corpus of text to learn word association. In some instances, a distance between the vectors reflects a semantic similarity between the corresponding semantic clusters, i.e., a smaller distance between two vectors corresponds to a greater similarity in semantic meanings between two corresponding semantic clusters. The distance between vectors may be a cosine distance, a Euclidean distance, or any other appropriate distance for vectors.

Various techniques may be used to determine a feature vector for a set of vectors. For example, a feature vector may be a mean vector or a weighted sum of the set of vectors. In another example, the server may combine the set of vectors into a matrix, calculate an eigenvector of the resulting matrix, and use the eigenvector as the feature vector. In yet another example, the server may use a trained machine learning model (such as Recurrent Neural Networks (RNN), Bidirectional Encoder Representations from Transformer (BERT), etc.) to determine a feature vector for the set of semantic clusters.

At block 417, upon determining a feature vector of the first prompt, the server may compare the feature vector of the first prompt to feature vectors of data and/or metric values associated with the property. The feature vectors of data and/or metric values may be created based upon descriptive information (e.g., labels) of the data and/or metric values in a similar manner as creating feature vectors of the first prompt. The server may then retrieve relevant data and/or metric values based upon the comparison. The server may retrieve data and/or metric values with feature vectors whose distances to the feature vector of the first prompt are below a distance threshold, and/or whose distances are among the smallest ones.

The server may then generate a second prompt based upon the retrieved data and/or metric values as described herein above with respect to block 420.

Turning back to FIG. 4A, after generating the second prompt, at block 430, the server may transmit the second prompt to the chatbot to generate a response. The response comprising a recommended action associated with the property. In some embodiments, the recommended action may include an improvement to a structure of the property, a replacement of a structure of the property, an addition of a structure to the property, and/or a removal of a structure from the property. In some embodiments, the recommended action may further include step-by-step instructions for performing the recommended action to allow the user to perform DIY (“Do It Yourself”) changes.

In some embodiments, the response may include an indication of a product and/or service associated with the recommended action, such as the indication 314. The indication of a product or service may be a Uniform Resource Locator (URL) associated with a vendor providing the product or service. To this end, the server may cause (e.g., via the second prompt or an additional prompt) the chatbot to generate keywords associated with the products or services and perform a search on the Internet and/or relevant databases using the keywords. For example, the chatbot may be trained to generate keywords associated with the recommendation in its response, e.g., generating keyword “shingle” when it recommends the user to replace the current shingles. The server may then use the keyword “shingle” to search for relevant products and/or services in a database or search engine and incorporate the search results into the response to be presented to the user.

At block 440, the server may present the response to the user, e.g., by transmitting the response to the user device and cause the user device to display it in a user interface of the user device. The server may present the response in texts or in audio, depending on the user's preference settings.

Turning to FIG. 4D, in some embodiments, the server may perform a method 400D to ensure that the recommendations presented to the user will improve the property. The method 400D may be performed as an alternative to or in addition to the embodiment where the chatbot is fine-tuned in connection with a feedback server as described above. That is, in some embodiments where the chatbot is fine-tuned using the property metrics, the chatbot may already be trained to maximize the property metrics, thereby avoiding the need to validate that the recommendations will improve the property.

In some instances, at block 432, the server may determine whether the second prompt includes property metrics at block 432. If the second prompt does not include property metrics, the server may proceed with presenting the response. Otherwise, if the second prompt includes property metrics, the server may proceed to block 434. According to certain aspects, the chatbot may be more capable of making certain property improvement recommendations effectively in view of property data than in view of property metrics because the property metrics may not include detailed information of the property's conditions. Accordingly, it may be advantageous (e.g., save computing resources) to perform the extra steps to ensure the effectiveness of recommendations when the recommendations are made based upon one or more property metrics.

In other instances, the server may perform block 434 without making the determination of block 432. At block 434, the server may re-calculate the property metrics as if the recommended action in the chatbot's response were implemented. For example, based upon the fact that the user's home has a low score of energy efficiency (i.e., a metric value associated with energy efficiency), the chatbot may recommend installing a solar panel on the roof to improve the energy efficiency. If a solar panel is not installed in the user's home already, the server may modify the data associated with the user's house as if the solar panel were installed. If a solar panel is installed in the user's home already, the server may maintain the data associated with the user's house. In some instances, the server may re-calculate the score of energy efficiency based upon the updated or maintained data. In other instances, the server may re-calculate the score of energy efficiency only if the data is updated.

At block 436, the server may determine whether the metric value increases after the re-calculation. An increase of the metric value may indicate that the recommendation in the chatbot's response would improve an aspect of the property. Accordingly, if the metric value increases after the re-calculation, the server may determine that the recommendation in the response is valid and proceed to block 438 and/or block 440. In some embodiments, the server may compare an increase (if any) of the metric value with a threshold. If the increase is greater than the threshold, the server may proceed to block 438 and/or block 440.

If the metric value does not increase after the re-calculation or, in some embodiments, the increase is no greater than a threshold, the server may determine that the recommendation in the response would not help improve the property. At block 442, the server may generate a new prompt to cause the chatbot to generate a new recommendation. For example, the new prompt may be “Your recommendation does not see to work. Can you make a new recommendation?” At block 444, the server may transmit the new prompt to the chatbot to generate a new response. The server may then perform blocks 432-444 until the recommendation in the chatbot's response would increase (or increase more than a threshold) a metric value of the property.

In some embodiments, there may be more than one recommendation in the chatbot's response. The server may process each of the recommendations in a similar manner described above.

If there are more than one valid recommendation in the response, at block 438, the server may determine the recommendation(s) to be presented to the user. For example, the server may select one or more recommendations based upon their corresponding changes of metric values, such as selecting the recommendations with greatest metric increases, or selecting the recommendations with metric increases exceeding a threshold (which may be different from the threshold used in some embodiments of block 436).

At block 440, the server may present a response including one or more recommendations to the user. In the scenario where the server selects all recommendations in a response from the chatbot or where the server does not perform a selection, the server may present the response from the chatbot to the user without modifying the response. In other scenarios where the server does not select all recommendations in the chatbot's response, the server may modify the response to remove the unselected recommendations from the response. For example, the server may simply remove the sentences corresponding to the unselected recommendations. In another example, the server may, after removing the unselected recommendations, reorganize the selected recommendations in an order of their corresponding metric increases. In yet another example, the server may feed the selected recommendation and, optionally, their corresponding metric increases to the chatbot to receive an organized response including the selected recommendations. After the modification, the server may present the response including the selected recommendations to the user.

In some embodiments, the server may receive an indication of whether the user accepts or rejects the recommended action. Responsive to an indication that the user accepts the recommended action, the server may determine a first insurance-related action. The first insurance-related action may include maintaining current insurance policy for the user, adding an additional policy, decreasing an insurance premium for the user, and/or increasing an insurance coverage for the user. Responsive to an indication that the user rejects the recommended action, determining, by the one or more processors, a second insurance-related action. The second insurance-related action may include maintaining current insurance policy for the user, declining to add an additional policy, increasing an insurance premium for the user, and/or decreasing an insurance coverage for the user.

It should be understood that not all blocks of the exemplary flow diagrams 400A-400D are required to be performed. It should be also understood that additional and/or alternative steps may be performed.

### V. Exemplary Embodiments

In one aspect, a computer-implemented method for providing property improvement recommendations is disclosed herein. The computer-implemented method may be implemented via one or more local or remote processors, servers, transceivers, sensors, memory units, mobile devices, wearables, smart watches, smart contact lenses, smart glasses, augmented reality (AR) glasses, virtual reality (VR) headsets, mixed reality (MR) or extended reality glasses or headsets, voice bots or chatbots, ChatGPT® or other GPT-based bots, and/or other electronic or electrical components, which may be in wired or wireless communication with one another. For example, in some embodiments, the method may include: (1) receiving, by one or more processors from a user, a first prompt associated with a property; (2) generating, by the one or more processors, a second prompt based upon the first prompt, data associated with the property and one or more property metrics associated with the property; (3) transmitting, by the one or more processors to a chatbot, the second prompt to generate a response, the response comprising a recommended action associated with the property; and/or (4) presenting, by the one or more processors, the response to the user, such as via textually, audibly, and/or visually. The method may include additional, less, or alternate functionality, including that discussed elsewhere herein.

For instance, in some embodiments, the one or more property metrics may be obtained by: (1) retrieving, by the one or more processors from a database, a plurality of factor scores associated with the property based upon the first prompt; and/or (2) determining, by the one or more processors, the one or more property metrics based upon the plurality of factor scores. Additionally or alternatively, the plurality of factor scores may include an environment score, a location score, a first responder score, a construction score, a usage score, an occupancy score, a risk score, home safety score, a fire protection score, a home automation score, and/or a sustainability score. Additionally or alternatively, at least a portion of the plurality of factor scores may be generated by a trained machine learning model.

In some embodiments, the data associated with the property may include an image associated with the property, an audio associated with the property, a video associated with property, inventory data associated with the property, and/or telematics data associated with the property.

In some embodiments, the chatbot may be trained with data associated with properties, property metrics associated with properties, prompts associated with properties, and recommendations associated with the data associated with properties, the property metrics associated with properties, and the prompts associated with the properties.

In some embodiments, the recommended action may include an improvement to a structure of the property, a replacement of a structure of the property, an addition of a structure to the property, and/or a removal of a structure from the property. Additionally or alternatively, the response may include step-by-step instructions for performing the recommended action.

In some embodiments, the response may include an indication of a product and/or service associated with the recommended action.

In some embodiments, the method may further comprise: (1) receiving, by the one or more processors, an indication of whether the user accepts or rejects the recommended action; (2) responsive to the indication that the user accepts the recommended action, determining, by the one or more processors, a first insurance-related action; and/or (3) responsive to the indication that the user rejects the recommended action, determining, by the one or more processors, a second insurance-related action.

In certain embodiments, the user may be a person, a computer, or a bot, such as ChatGPT-based bot, and the response may be a virtual, visual, online, graphical, text, text-based, textual, audible, verbal, code-based, or other response. The response may be meant for consumption or use by a person, computer, or bot.

In one aspect, a computer system for providing property improvement recommendations is disclosed herein. The computer system may include one or more local or remote processors, servers, transceivers, sensors, memory units, mobile devices, wearables, smart watches, smart contact lenses, smart glasses, augmented reality (AR) glasses, virtual reality (VR) headsets, mixed reality (MR) or extended reality glasses or headsets, voice bots or chatbots, ChatGPT® or other GPT-based bots, and/or other electronic or electrical components, which may be in wired or wireless communication with one another. For example, in some embodiments, the computer system may comprise: (1) one or more processors, and (b) a memory storing executable instructions thereon. The instructions, when executed by the one or more processors, may cause the one or more processors to: (1) receive, from a user, a first prompt associated with a property; (2) generate a second prompt based upon the first prompt, data associated with the property and one or more property metrics associated with the property; (3) transmit, to a chatbot, the second prompt to generate a response, the response comprising a recommended action associated with the property; and/or (4) present the response to the user, such as verbally, textually, visually, or graphically. The computer system may include additional, less, or alternate functionality, including that discussed elsewhere herein.

For example, in some embodiments, to obtain the one or more property metrics, the executable instructions, when executed by the one or more processors, may cause the one or more processors to: (1) retrieve, from a database, a plurality of factor scores associated with the property based upon the first prompt; and/or (2) determine the one or more property metrics based upon the plurality of factor scores. Additionally or alternatively, the plurality of factor scores may include an environment score, a location score, a first responder score, a construction score, a usage score, an occupancy score, a risk score, home safety score, a fire protection score, a home automation score, and/or a sustainability score. Additionally or alternatively, at least a portion of the plurality of factor scores may be generated by a trained machine learning model.

In some embodiments, the data associated with the property may include an image associated with the property, an audio associated with the property, a video associated with property, inventory data associated with the property, and/or telematics data associated with the property.

In some embodiments, the chatbot may be trained with data associated with properties, property metrics associated with properties, prompts associated with properties, and recommendations associated with the data associated with properties, the property metrics associated with properties, and the prompts associated with the properties.

In some embodiments, the recommended action may include an improvement to a structure of the property, a replacement of a structure of the property, an addition of a structure to the property, and/or a removal of a structure from the property. Additionally or alternatively, the response further includes step-by-step instructions for performing the recommended action.

In some embodiments, wherein the response further includes an indication of a product and/or service associated with the recommended action. As noted previously, in certain embodiments, the user may be a person, a computer, or a bot, such as ChatGPT-based bot, and the response may be a virtual, visual, online, graphical, text, text-based, textual, audible, verbal, code-based, or other response. The response may be meant for consumption or use by a person, computer, or bot.

In one aspect, a computer readable storage medium storing non-transitory computer readable instructions for providing property improvement recommendations is disclosed. The non-transitory computer readable instructions, when executed on one or more processors, may cause the one or more processors to: (1) receive, from a user, a first prompt associated with a property; (2) generate a second prompt based upon the first prompt, data associated with the property and one or more property metrics associated with the property; (3) transmit, to a chatbot, the second prompt to generate a response, the response comprising a recommended action associated with the property; and/or (4) present the response to the user. The instructions may direct additional, less, or alternate functionality, including that discussed elsewhere herein.

### VI. Additional Considerations

Although the term “property” as used herein generally refers to a real property (e.g., a residence home, a commercial building, etc.), one of ordinary skill in the art will appreciate that the method and system disclosed herein also apply to certain personal properties, such as an automobile.

Unless otherwise indicated, the processes implemented by an ML chatbot may be implemented by an ML voice bot, an AI chatbot, an AI voice bot, and/or a large language model (LLM).

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based upon the application of 35 U.S.C. § 112(f).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

The systems and methods described herein are directed to an improvement to computer functionality, and improve the functioning of conventional computer systems.

What is claimed is:

1. A computer-implemented method providing property improvement recommendations, the method comprising:
receiving, by one or more processors from a user, a first prompt associated with a property;
generating, by the one or more processors, a second prompt based upon the first prompt, data associated with the property and one or more property metrics associated with the property;
transmitting, by the one or more processors to a chatbot, the second prompt to generate a response, the response comprising a recommended action associated with the property; and
presenting, by the one or more processors, the response to the user.

2. The computer-implemented method of claim 1, wherein the one or more property metrics are obtained by:
retrieving, by the one or more processors from a database, a plurality of factor scores associated with the property based upon the first prompt; and
determining, by the one or more processors, the one or more property metrics based upon the plurality of factor scores.

3. The computer-implemented method of claim 2, wherein the plurality of factor scores includes an environment score, a location score, a first responder score, a construction score, a usage score, an occupancy score, a risk score, home safety score, a fire protection score, a home automation score, and/or a sustainability score.

4. The computer-implemented method of claim 3, wherein at least a portion of the plurality of factor scores are generated by a trained machine learning model.

5. The computer-implemented method of claim 1, wherein the data associated with the property includes an image associated with the property, an audio associated with the property, a video associated with property, inventory data associated with the property, and/or telematics data associated with the property.

6. The computer-implemented method of claim 1, wherein the chatbot is trained with data associated with properties, property metrics associated with properties, prompts associated with properties, and recommendations associated with the data associated with properties, the property metrics associated with properties, and the prompts associated with the properties.

7. The computer-implemented method of claim 1, wherein the recommended action includes an improvement to a structure of the property, a replacement of a structure of the property, an addition of a structure to the property, and/or a removal of a structure from the property.

8. The computer-implemented method of claim 7, wherein the response further includes step-by-step instructions for performing the recommended action.

9. The computer-implemented method of claim 1, wherein the response further includes an indication of a product and/or service associated with the recommended action.

10. The computer-implemented method of claim 1, further comprising:
receiving, by the one or more processors, an indication of whether the user accepts or rejects the recommended action;
responsive to the indication that the user accepts the recommended action, determining, by the one or more processors, a first insurance-related action; and
responsive to the indication that the user rejects the recommended action, determining, by the one or more processors, a second insurance-related action.

11. A computer system for providing property improvement recommendations, the computer system comprising:
one or more processors; and
a memory storing executable instructions thereon that, when executed by the one or more processors, cause the one or more processors to:
receive, from a user, a first prompt associated with a property;
generate a second prompt based upon the first prompt, data associated with the property and one or more property metrics associated with the property;
transmit, to a chatbot, the second prompt to generate a response, the response comprising a recommended action associated with the property; and
present the response to the user.

12. The computer system of claim 11, wherein to obtain the one or more property metrics, the executable instructions, when executed by the one or more processors, further cause the one or more processors to:
retrieve, from a database, a plurality of factor scores associated with the property based upon the first prompt; and
determine the one or more property metrics based upon the plurality of factor scores.

13. The computer system of claim 12, wherein the plurality of factor scores includes an environment score, a location score, a first responder score, a construction score, a usage score, an occupancy score, a risk score, home safety score, a fire protection score, a home automation score, and/or a sustainability score.

14. The computer system of claim 13, wherein at least a portion of the plurality of factor scores are generated by a trained machine learning model.

15. The computer system of claim 11, wherein the data associated with the property includes an image associated with the property, an audio associated with the property, a video associated with property, inventory data associated with the property, and/or telematics data associated with the property.

16. The computer system of claim 11, wherein the chatbot is trained with data associated with properties, property metrics associated with properties, prompts associated with properties, and recommendations associated with the data associated with properties, the property metrics associated with properties, and the prompts associated with the properties.

17. The computer system of claim 11, wherein the recommended action includes an improvement to a structure of the property, a replacement of a structure of the property, an addition of a structure to the property, and/or a removal of a structure from the property.

18. The computer system of claim 17, wherein the response further includes step-by-step instructions for performing the recommended action.

19. The computer system of claim 11, wherein the response further includes an indication of a product and/or service associated with the recommended action.

20. A computer readable storage medium storing non-transitory computer readable instructions for providing property improvement recommendations, wherein the instructions when executed on one or more processors cause the one or more processors to at least:
receive, from a user, a first prompt associated with a property;
generate a second prompt based upon the first prompt, data associated with the property and one or more property metrics associated with the property;
transmit, to a chatbot, the second prompt to generate a response, the response comprising a recommended action associated with the property; and
present the response to the user.
